(19) United States
(12) Patent Application Publication
(10) Pub. No.: US 2003/0103243 A1
(43) Pub. Date: Jun. 5, 2003

(54) Transmission system

(76) Inventors: Hideaki Watanabe, Kawasaki (JP); Akira Nakagawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/116,928

(22) Filed: Apr. 5, 2002

(30) Foreign Application Priority Data
Nov. 30, 2001 (JP) 2001-366043

(51) Int. Cl. H04N 1/00

(52) U.S. Cl. 358/405

(57) ABSTRACT

A proposed transmission system is capable of setting an optimal transmission rate at which high-quality packet transmission can be realized with reduced packet loss. A packet generating part divides encoded media data represented or output at an identical time into packets. A receiving condition information acquiring part acquires receiving condition information about a condition of receiving the packets from an opposing device. A packet sending part, based on the receiving condition information, adjusts intervals at which the packets are sent so that a transmission rate can be varied and performs a sending control of the packets. A receiving condition information generating part receives the packets, generates the receiving condition information, and sends the receiving condition information to the packet sending device.

### BACKGROUND OF THE INVENTION

1. Field of the Invention

The present invention relates to transmission systems, and more particularly, to a transmission system that transfers packets via a network.

2. Description of the Related Art

There has been considerable activity in the development of transmission technologies about real time multimedia such as moving image data with practical application of multimedia service. Digitized image data has a huge amount of information and is encoded at a bit rate that matches the transmission band before transmission.

Image encoding typically employs MPEG. In order to simultaneously obtain a desired high compression rate and high picture quality, image encoding uses an intraframe predictive picture (I picture) and an interframe forward predictive picture (P picture) are introduced. A larger amount of information is allotted to the I picture than to the P picture, and is then encoded.

In transmission of a picture to which a large amount of information is allotted, if the picture is transferred at its encoding rate (fixed), in other words, if the picture is transferred at a transmission rate nearly equal to the encoding rate, it will take a long delay of time to retrieve the picture received at the receiving side. In order to prevent such a delay in retrieval it is required to transmit the picture at a transmission rate higher than the encoding rate.

However, a problem of loss of packet will arise from a mere increase of the transmission rate from the encoding rate although the starting time of the delay in retrieval can be shortened.

A packet may be discarded if a router in the network operates with a high load. Loss of packet degrades the transmission quality. If the packets are transferred at an increased transmission rate without any consideration of a transmission delay stemming from a network congestion, loss of packet will increase.

### SUMMARY OF THE INVENTION

Taking the above into consideration, it is an object of the present invention to provide a transmission system capable of setting an optimal transmission rate at which loss of packet does not occur and transferring packets with high reliability.

The above object of the present invention is achieved by a transmission system transferring packets via a network comprising:

a packet sending device including a packet generating part dividing encoded media data represented or output at an identical time into packets, a receiving condition information acquiring part acquiring receiving condition information about a condition of receiving the packets from an opposing device, and a packet sending part adjusting intervals at which the packets are sent so that a transmission rate can be varied and performing a sending control of the packets; and a packet receiving device including a receiving condition information generating part receiving the packets, generating the receiving condition information, and sending the receiving condition information to the packet sending device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram of the principles of a transmission system according to the present invention;

FIG. 2 is a graph describing a concept of VBV;

FIG. 3 is a graph describing an increase in delay of time in retrieval start;

FIG. 4 is a graph showing a condition of a receiving buffer at the time of burst transmission;

FIG. 5 is a block diagram of a concept of packet communication using a RTP/RTCP-based transmission system of the present invention;

FIG. 6 is a block diagram of a server;

FIG. 7 is a view of receiving condition information included in an RR packet; and

FIG. 8 is a view of a concept of packet transmission interval adjustment control.

### DESCRIPTION OF THE PREFERRED EMBODIMENTS

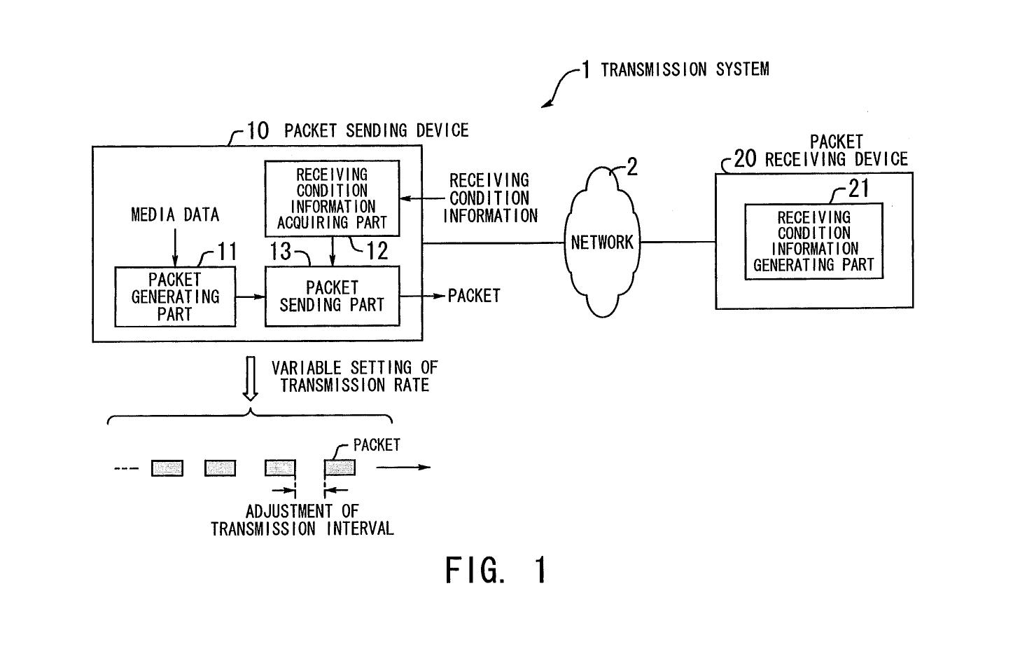

A description will now be given of embodiments of the present invention with reference to the accompanying drawings. FIG. 1 shows the principles of a transmission system. A transmission system 1 is made up of a packet sending device 10 and a packet receiving device 20, between which packets are transferred via a network 2. The functions of the packet sending device 10 and the packet receiving device 20 according to the present invention may be implemented in a single transmission device in practice.

A packet generating part 11 of the packet sending device 10 divides media data (audio/video data: AV data) encoded by MPEG or the like and represented or output at the same time into packets.

For example, for consecutive video frames respectively represented at times t1 and t2 at the receiving side, the video frame represented at time t1 is divided into five packets, and the video frame represented at time t2 is divided into six packets.

A receiving condition information acquiring part 12 acquires information about the packet receiving condition from an opposing side (packet receiving device 20). As the receiving condition information, at least one of loss-of-packet information and information about transmission delay is acquired.

The loss-of-packet information indicates the ratio of packets lost to all the packets received by the packet receiving device 20. The transmission delay information indicates the time of transmission delay it takes the packet sent by the packet sending device 10 to arrive at the packet receiving device 20.

A packet sending part 13 adjusts the packet transmission intervals based on the receiving condition information, and dynamically sets the transmission rate at which the packets are transferred.

The packet sending part 13 sets the transmission rate higher than the encoding rate for media data if it does not recognize the occurrence of loss of packet or transmission delay (“occurrence” means an increasing trend in the present invention), and sets the transmission rate close to the encoding rate if loss of packet or transmission delay is recognized.

A receiving condition information generating part 21 of the packet receiving device 20 receives packets and generates receiving condition information thereon, sending it to the packet sending device 10.

Now, a VBR (Variable Bit Rate) and a CBR (Constant Bit Rate) are described. Generally, picture information is encoded in advance of transmission. VBR Encoding is frequently employed in an environment in which data can be read directly from a recording medium at a high rate without passing through a network, such as DVD. In digital broadcasting, CBR encoding is generally employed.

The VBR is used to control the amount of information that is encoded at a variable bit rate. However, in practice, there is a limit on the average read rate and the peak read rate due to the nature of the recording medium. The average bit rate over a certain time may be equal to a constant amount of information.

In practice, the CBR does not encode information so that every video frame has the same amount of information, but allows a difference in the amount of information between frames in MPEG. An encoding that guarantees a constant amount of information over hundreds of milliseconds to a few seconds is called CBR although it depends on applications.

That is, the difference between the VBR and CBR merely depends on whether the interval at which the constant amount of information is guaranteed is long or short. In many cases using the VBR, encoding is carried out so that a constant amount of data is substantially handled over a time range of tens of seconds to a few minutes.

Consequently, the encoding rate for picture data can be deemed to be constant over a certain time irrespective of whether the VBR or CBR is employed. In the following description, a bit stream encoded at a certain rate is employed.

Next, a delay in the retrieval starting time is described. First, VBV (Video Buffering Verifier) of MPEG video encoding (MPEG Video Elementary Stream; hereinafter referred to as MPEG Video ES) is described.

In the MPEG Video ES, conditions required by a hypothetical buffer called VBV must be satisfied, and the encoder encodes data so that the VBV on the decoder side does not underflow or overflow.

More particularly, on the encoder side, 16-bit information called vbv delay is added to the head of every frame. The above information is used to set the time from buffer input to retrieval in the buffer on the decoder side. The vbv delay enables the decoder to know the frame retrieval timing.

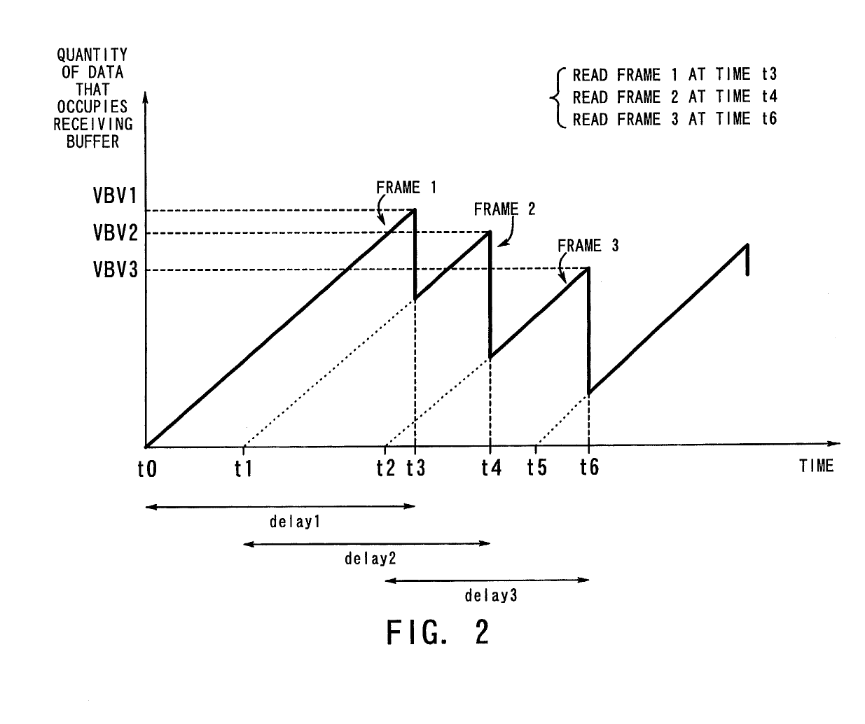

FIG. 2 shows the concept of VBV. More particularly, this figure shows how the amount of data that occupies the receiving buffer on the decoder side varies with retrieval of frames. The vertical axis of the figure denotes the amount of data that occupies the receiving buffer, and the horizontal axis thereof denotes time.

The vbv delay of MPEG Video ES is represented as time information on the 90 kHz basis (1/90000 sec basis), and the buffer occupying quantity VBVn for decoding frame n can be obtained as follows:

VBVn=transmission bit rate for one frame x(vbv delay n/90000) (1)

When the buffer occupying quantity becomes equal to VBVn by equation (1), data of the frame n is read from the receiving buffer and is processed for retrieval. In FIG. 2, frame 1 is received and buffered at time t0, and is read at time t3 when the buffer occupying quantity becomes equal to VBV1. Frame 2 is received and buffered at time t1, and is read at time 4. The same operation as described above follows.

The delays of time necessary to retrieve frames 1 to 3 are respectively delay 1 to delay 3. The slant in the graph depends on the transmission rate.

The above control guarantees retrieval of successive frames without any overflow or underflow at the receiving buffer. In a case where the frames are transported at the transmission rate equal to the encoding rate (that is, the frames are transported at the minimum rate), if the amount of information per frame is large, the quantity of data to be received up to retrieval increases. This increases the delay in the retrieval start time.

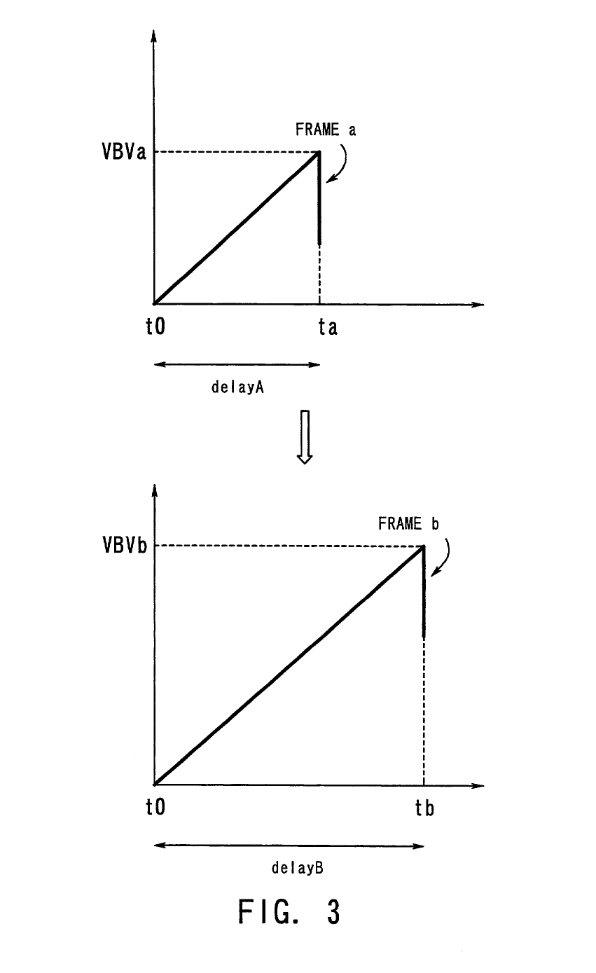

FIG. 3 shows an increased delay in the retrieval start time, in which the vertical axis denotes the buffer occupying quantity and the horizontal axis denotes time. Frame a is received and buffered at time t0, and is read at time ta when the buffer occupying quantity becomes equal to VBVa. The retrieval start delay of time is delayA.

A case is now considered where a frame b is transmitted at the same transmission rate (the same slant) as that at which frame a is transmitted in which frame b has a larger amount of information than frame a. Frame b is received and buffered at time t0, and is read at time tb (>ta) when the buffer occupying quantity becomes equal to VBVb (>VBVa). The delay in retrieval start time is delayB. That is, delayB>delayA. As the quantity of information per frame increases, the delay of time in the retrieval start increases.

As described above, the delay of time in the retrieval start increases for frames that are transmitted at rates nearly equal to the encoding rate and are assigned a large amount of information. The present invention assumes that the transmission rate is higher than the encoding rate. Hereinafter, such a transmission is called burst transmission.

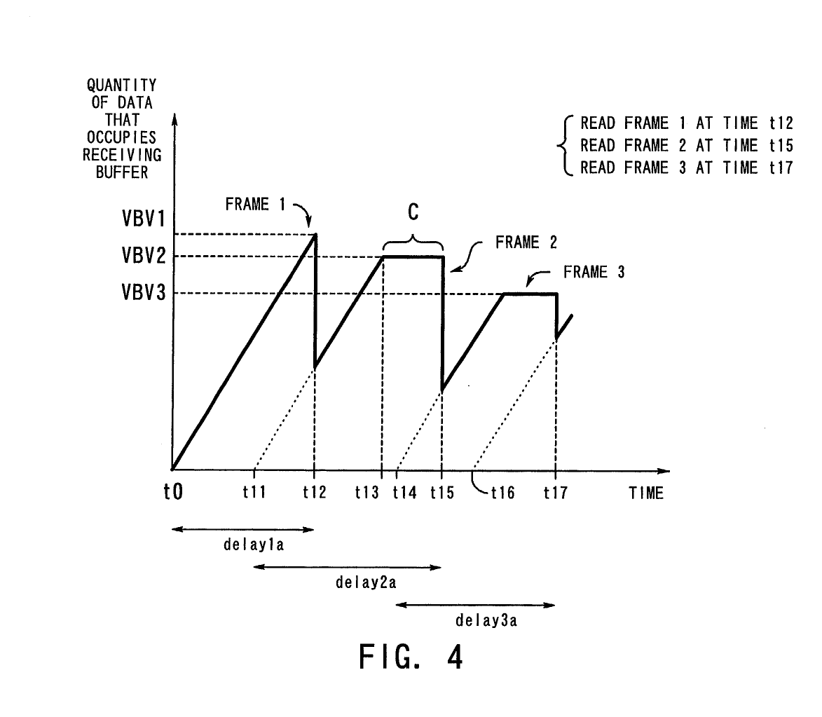

FIG. 4 shows the condition of the receiving buffer at the time of burst transmission, in which the vertical axis denotes the receiving buffer occupying quantity, and the horizontal axis denotes time. Frame 1 is received and buffered at time t0, and is read at time t12 when the buffer occupying quantity becomes equal to VBV1. Frame 2 is received and buffered at time t11, and is read at time t15. The same operation as described above follows.

Since the transmission rate is selected so as to be higher than the encoding rate, The slants of the graph for frames 1 to 3 are sharper than those for the corresponding frames shown in FIG. 2. In other words, the time necessary for buffering at the receiving side can be shortened due to burst-like transmission of frames.

In FIG. 4 there are some flat portions in which the buffer occupying amount is constant. As to section C in frame 2, all of frame 2 is received at time t13 and is read at time t15. It means that data stays for the section C in the buffer.

The delays of time in retrieval start for frames 1-3 are respectively delay1a-delay3a. As compared to FIG. 2, they are delay1>delay1a, delay2>delay2a, delay3>delay3a. The burst transmission reduces the delays of time in retrieval start.

Simple burst transmission that attempts to reduce the delays of time in retrieval start would increase the ratio of packets lost in the network.

The present invention primarily employs burst transmission directed to reducing the delays of times in retrieval start, and has an additional structure directed to suppression of occurrence of packets lost by setting the rate of the burst transmission close to the encoding rate if an increase of packets lost is recognized by provisioning using the information concerning the receiving condition sent by the packet receiving device 20. As described above, the transmission rate is variably set so that the optimal transmission rate dependent on the network condition is determined.

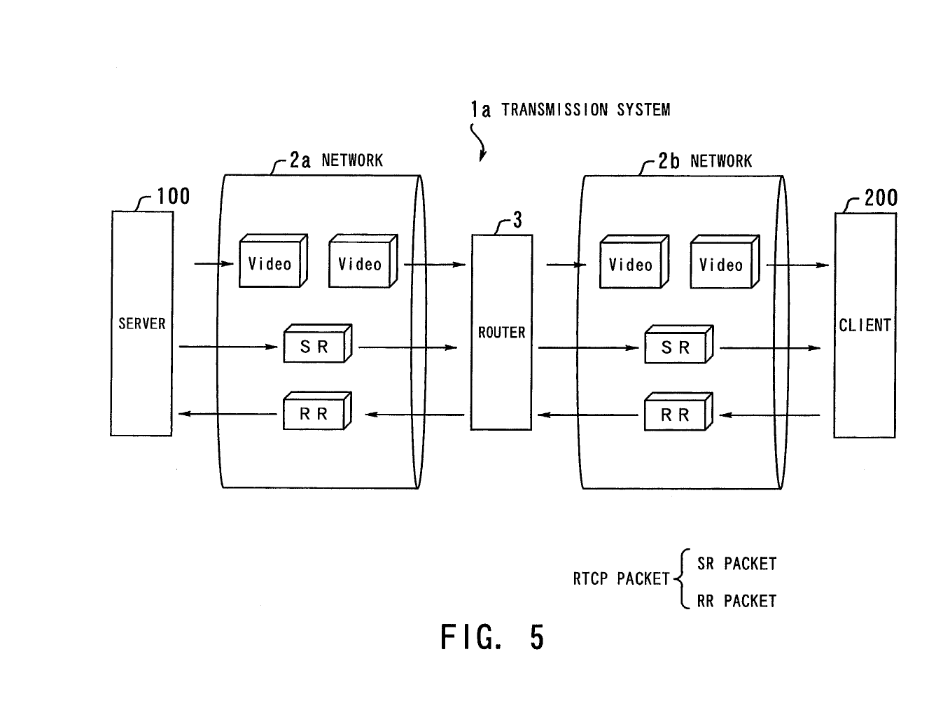

Next, a description will be given of an embodiment of the present invention in which the transmission system 1 of the invention is applied to a system based on RTP (Real-time Transport Protocol/RTCP (Real-Time Control Protocol). FIG. 5 shows the concept of packet communication in the RTP/RTCP-based transmission system of the present invention.

RTP is a data transfer protocol that is located in the transport layer and operates on UDP and ATM AAL5 used for real-time delivery of a data stream of audio and video.

RTCP is a control protocol used for evaluating the channel quality in RTP-based packet communication. In order to generate a stream data that conforms to the channel quality, an RTCP packet is periodically transferred between the sending and receiving terminals (an idea that does not require a network device such as a router to control the band guarantee).

A transmission system 1a is made up of a server 100 (which corresponds to the packet sending device 10), and a client device 200 (which corresponds to the packet receiving device 20). The transmission system 1a sends and receives packets to and from networks 2a and 2b connected via a router 3.

The server 100 sends an RTP packet including video data to the client device 200. RTCP packets are transferred between the server 100 and the client device 200.

In the following, an RTCP packet sent to the client device 200 from the server 100 is referred to as an SR (Sender Report) packet, and an RTCP packet sent to the server 100 from the client device 200 is referred to as an RR (Receiver Report) packet.

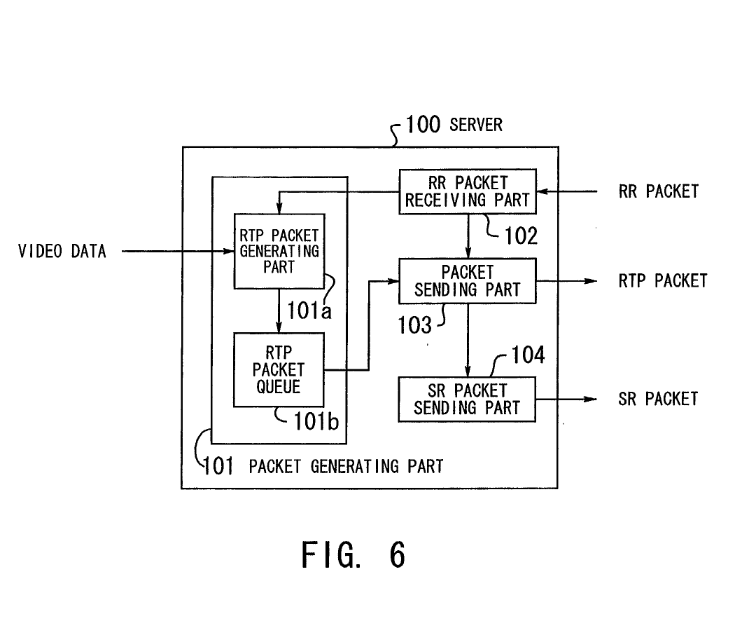

Next, the server 100 is described. FIG. 6 is a block diagram of a structure of the server 100, which is made up of a packet generating part 101, an RR packet receiving part 102, a packet sending part 103, and an SR packet sending part 104. The packet generating part 101 is made up of an RTP packet generating part 101a, and an RTP packet queue 101b.

The RTP packet generating part 101a receives digital video data, and encodes it at CBR according to MPEG4. In MPEG4, one frame of video is called VOP (Video Object Plane), and one VOP is divided into units called video packets, which are then encoded.

It is free to determine how many units one VOP is divided. When video data conforming to MPEG4 is transported at RTP, an RTP packet is generated in VOP or a video packet boundary (recommended by IETF RFC3016).

Here, it is assumed that the RTP packet is generated in accordance with the above-mentioned specification. If the packet size of the RTP packet goes beyond MTU (Maximum Transfer Unit: the maximum length of an IP packet) of the network, it is divided into parts equal to or smaller than MTU.

The RTP packet queue 101b temporarily stores the RTP packet, which is then read by the packet transmission part 103 and is sent to the client device 200.

The RR packet receiving part 102 acquires (extracts) information about the receiving condition from the RR packet received, and notifies the information about the receiving condition of the packet sending part 103.

The packet sending part 103 sets the optimal transmission rate from the information about the receiving condition, and sends the RTP packet. The SR packet sending part 104 periodically acquires necessary information from the packet sending part 103, and generates the SR packet, which is then sent to the client device 200.

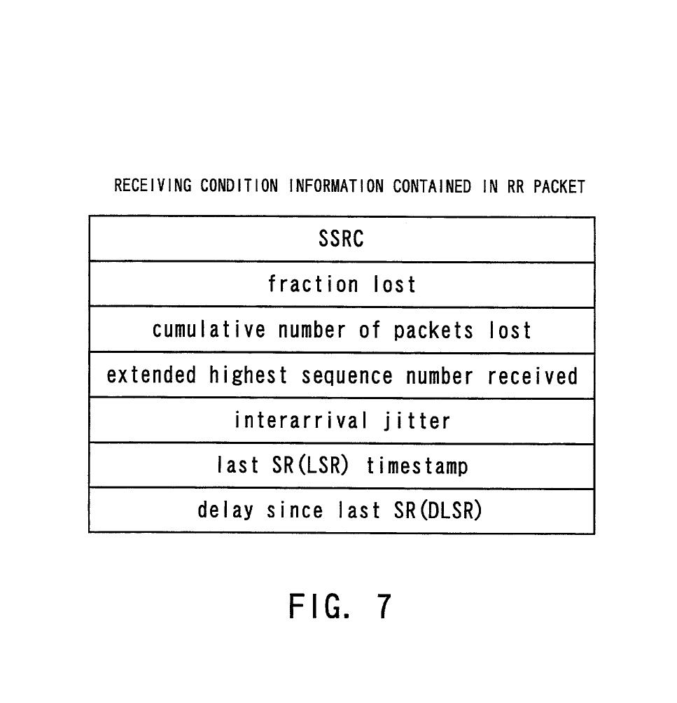

FIG. 7 is a view of the information concerning the receiving condition contained in the RR packet. A field “SSRC” (synchronization source) is an ID of the sender terminal. A field “fraction lost” is the ratio of packets lost to an expected number of packets received after the immediately previous SR packet or RR packet is sent. A field “cumulative number of packets lost” is the cumulative number of packets lost after the receiving is started.

A field “extended highest sequence number received” is the highest sequence number of the packet received previously. A field “interarrival jitter” indicates the quantity of jitter at intervals at which packets arrive. A field “last SR (LSR) timestamp” is the timestamp of the last SR packet. A field “delay since last SR (DLSR)” is a delay of time from the time of receipt of the last SR packet to the time of sending its RR packet.

In the server 100, timestamp information and the cumulative number of packets/bytes sent are stored in the SR packet and are then sent. When the server 100 receives the RR packet, it is possible to recognize the conditions in which loss of packets occurs from the “fraction lost” and the “cumulative number of packets lost”.

The RTT (roundtrip time: the time it takes the packet sent to arrive at the destination and receive its response) regarding the transmission delay is computed by RTT=(T−LSR−DLSR) where T denotes the time when the RR packet is received. In the above manner, the network delay can be estimated.

The server 100 consecutively measures the rate of the packets lost and the network delay on the receiving side, and thus recognizes change of the transfer performance of the network. The present invention optimizes the packet transmission rate using not only the information (fraction lost, cumulative number of packets lost) about the receiving condition with which an increase in packet loss is directly recognizable, but also information (LSR timestamp, DLSR) about the receiving condition used for notice of the transmission delay (it is possible to estimate an increase in packet loss by recognizing an increase in transmission delay).

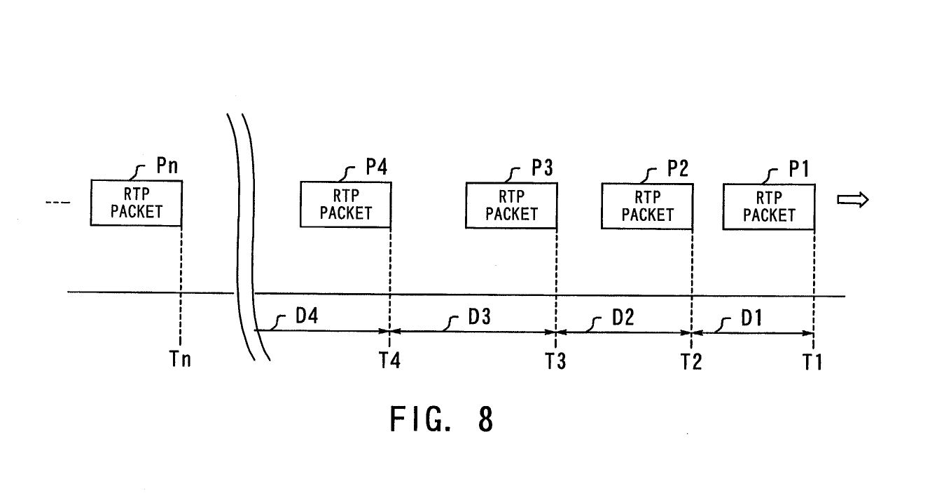

A description will now be given of sending interval adjustment control by the packet sending part 103. FIG. 8 shows the concept of the packet sending interval adjustment control. RTP packets P1-Pn are respectively sent at times T1-Tn. D1-Dn are the differences between the adjacent times (time intervals for sending). The packets P1-Pn have quantities I1-In of data.

The interval time D for sending, the quantity I of packet information, and the target transmission rate B have the following relationship:

D=I/B (2)

It is now assumed that RTP packet P1 is sent at time T1. In order to make the transmission rate equal to B, RTP packet P2 is sent at time T2 which is D1=I1/B spaced apart from time T1. In other words, the sending interval D1 is adjusted so that the bit rate required for I1/D1 becomes equal to the target transmission rate B. By adjusting the sending interval D, it is possible to make the transmission rate close to the target value B.

When the target value B corresponds to the encoding rate, it is possible to maintain a condition in which data to be sent is always available. If the target value B exceeds the encoding rate, a condition occurs in which no data for transmission is available. This is because a condition in which data equal to vbv delay necessary for decoding of the above-mentioned one frame has been sent.

If transmission is temporarily interrupted as described above, the computation of the transmission rate does not consider the waiting time, and newly adjusts the transmission rate from the beginning packet when data transmission necessary for decoding of the next frame starts.

The upper limit Bmax of the transmission rate B is set equal to the maximum transfer band rate of the network, and the lower limit Bmin thereof is set equal to the encoding rate. According to the present invention, the optimal transmission rate B is set so as to meet Bmin≦B≦Bmax.

Next, a description will be given of control of setting of the optimal transmission rate. At the commencement of transmission, the server 100 performs burst transmission. The RR packet receiving part 102 obtains information about the transmission delay and the ratio of packets lost from the received RR packet. The packet sending part 103 adjusts the transmission intervals D(making the intervals wider) and makes the transmission rate of the RTP packet close to the encoding rate when recognizing an increase in the transmission delay or the ratio of packets lost.

At the commencement of transmission, the transmission rate may be made equal to the encoding rate, and is gradually set in a burst fashion if the information about the receiving condition in the RR packet exhibits that neither transmission delay nor packet loss is recognized (making the intervals narrower).

If the ratio of packets lost is not improved after burst transmission is ceased, it is recognized that the transmission rate itself exceeds the transmission band. Thus, the RR packet receiving part 102 controls the RTP packet generating part 101a to suppress the quantity of information that occurs.

If the transmission rate is changed at the sending side, data to be retrieved at the reception side may be temporarily in short or excessive. In such as case, the frame rate is adequately increased or decreased at the receiving side in order to adjust the retrieval rate. This prevents degradation of the quality of retrieval.

As described above, according to the present invention, the packet transmission intervals are adjusted based on the information about the receiving condition obtained from the opposing side, and the transmission rate is varied without changing the picture quality (without changing the encoding rate). It is therefore possible to realize high-quality packet transfer with loss of packets being reduced. Particularly, the present invention is advantageous to transmission of data at a frame rate as low as a few fps (frames per second).

As described above, the transmission system of the present invention adjusts the packet transmission interval based on information concerning the receiving condition obtained from the opposing device and dynamically adjusts the transmission rate. It is therefore possible to set the transmission rate optimal to suppression of occurrence of packet loss and realize highly reliable packet transmission.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A transmission system transferring packets via a network comprising:
a packet sending device including a packet generating part dividing encoded media data represented or output at an identical time into packets, a receiving condition information acquiring part acquiring receiving condition information about a condition of receiving the packets from an opposing device, and a packet sending part, based on the receiving condition information, adjusting intervals at which the packets are sent so that a transmission rate can be varied and performing a sending control of the packets; and
a packet receiving device including a receiving condition information generating part receiving the packets, generating the receiving condition information, and sending the receiving condition information to the packet sending device.

2. The transmission system according to claim 1, wherein the receiving condition information acquiring part acquires, as the receiving condition information, at least one of packet loss information and transmission delay information.

3. The transmission system according to claim 1, where the packet sending part sets the transmission rate higher than an encoding rate if occurrence of a transmission delay or packet loss is not recognized and sets the transmission rate close to the encoding rate if occurrence of a transmission delay or packet loss is recognized, so that an optimal transmission rate for packet transmission can be set.

4. The transmission system according to claim 1, wherein the packet sending part adjusts transmission intervals D for change of the transmission rate so that a bit rate I/D becomes equal to a target transmission rate B and sends the packets where D denotes packet transmission intervals and I denotes a quantity of packet information.

5. The transmission system according to claim 1, wherein the packet sending part uses an upper limit value of the transmission rate as a maximum transmission band rate of the network, and a lower limit value thereof as an encoding rate.

6. A packet transmission device sending packets via a network comprising:
a packet generating part dividing encoded media data represented or output at an identical time into packets;
a receiving condition information generating part receiving the packets, generating receiving condition information, and sending the receiving condition information to a device of sending side;
a receiving condition information acquiring part acquiring the receiving condition information from a device of receiving side; and
a packet sending part, based on the receiving condition information, adjusting intervals at which the packets are sent so that a transmission rate can be varied and performing a sending control of the packets.

7. A transmission system performing transmission control based on RTP/RTCP comprising:
a server including a packet generating part dividing encoded media data represented or output at an identical time into RTP packets, a receiving condition information acquiring part acquiring receiving condition information about a condition of receiving the RTP packets from an RTCP packet sent by an opposing device, and a packet sending part, based on the receiving condition information, adjusting intervals at which the RTP packets are sent so that a transmission rate can be varied and performing a sending control of the RTP packets;
a client device including a receiving condition information generating part receiving the RTP packets, generating the receiving condition information, and sending the RTCP packet including the receiving condition information to the server.

8. The transmission system according to claim 7, wherein the receiving condition information acquiring part acquires, as the receiving condition information, at least one of packet loss information and transmission delay information.

9. The transmission system according to claim 7, where the packet sending part sets the transmission rate higher than an encoding rate if occurrence of a transmission delay or packet loss is not recognized and sets the transmission rate close to the encoding rate if occurrence of a transmission delay or packet loss is recognized, so that an optimal transmission rate for packet transmission can be set.

10. The transmission system according to claim 7, wherein the packet sending part adjusts transmission intervals D for change of the transmission rate so that a bit rate I/D becomes equal to a target transmission rate B and sends the RTP packets where D denotes RTP packet transmission intervals and I denotes a quantity of RTP packet information.

11. The transmission system according to claim 7, wherein the packet sending part uses an upper limit value of the transmission rate as a maximum transmission band rate of the network, and a lower limit value thereof as an encoding rate.

12. A packet transmission device performing transmission control based on RTP/RTCP comprising:
a packet generating part dividing encoded media data represented or output at an identical time into RTP packets;
a receiving condition information generating part receiving the RTP packets, generating receiving condition information, and sending an RTCP packet including the receiving condition information to a server;
a receiving condition information acquiring part acquiring the receiving condition information from the RTCP packet from a client device; and
a packet sending part, based on the receiving condition information, adjusting intervals at which the RTP packets are sent so that a transmission rate can be varied and performing a sending control of the RTP packets.
